(19) United States
(12) Patent Application Publication
(10) Pub. No.: US 2026/0009684 A1
(43) Pub. Date: Jan. 8, 2026

(54) STRAIN GAUGE SENSOR

(71) Applicant: International Business Machines Corporation, Armonk, NY (US)

(72) Inventors: Nicholas Latham, Albany, NY (US); Kishan Jayanand, COHOES, NY (US); Nicholas Alexander POLOMOFF, Hopewell Junction, NY (US); Mukta Ghate Farooq, Hopewell Junction, NY (US); Ashim Dutta, Clifton Park`, NY (US); Chih-Chao Yang, Glenmont, NY (US)

(21) Appl. No.: 18/763,041

(22) Filed: Jul. 3, 2024

(51) Int. Cl. G01L 1/22

(52) U.S. Cl. CPC G01L 1/2293; G01L 1/2212

(57) ABSTRACT

A structure including an in-situ strain gauge sensor is provided. The in-situ strain gauge sensor is formed at a hybrid bonding interface between a carrier substrate and a device substrate. The strain gauge sensor leverages the piezoresistive effect where the resistance of conductive materials change in response to mechanical strain. The voltage output can be modeled to understand strain where resistance will change based on the applied strain on the structure that contains the in-situ strain gauge sensor.

### BACKGROUND

The present application relates to semiconductor technology, and more particularly to a structure including a strain gauge sensor that is located at a hybrid bonding interface that is present between a device substrate and a carrier substrate.

Strain gauge sensors have become a fundamental component in various industries. A strain gauge sensor is a device that converts mechanical deformation, such as elongation or compression, into an electrical signal. This is achieved through a simple mechanism; as the strain gauge sensor is subjected to stress, the sensor's electrical resistance changes proportionally. The fundamental principal behind this phenomenon is the piezoresistive effect, which describes how the electrical resistivity of a material changes as a result of applied mechanical stress.

Typically, a strain gauge sensor includes a thin, flexible backing material with a conductive pattern made from a metal wire or metal foil. The conductive pattern is arranged in a grid-like structure, allowing the structure to change its shape as the backing material deforms. The change in the conductive pattern's geometry results in a proportional change in its electrical resistance, which can then be measured and correlated to the applied strain.

### SUMMARY

A structure including an in-situ strain gauge sensor is provided. The in-situ strain gauge sensor is formed at a hybrid bonding interface between a carrier substrate and a device substrate. The strain gauge sensor leverages the piezoresistive effect where the resistance of conductive materials change in response to mechanical strain. The voltage output can be modeled to understand strain where resistance will change based on the applied strain on the structure that contains the in-situ strain gauge sensor.

In one embodiment of the present application, the structure includes a device substrate including at least one pair of spaced apart metal wires extending entirely through the device substrate, and a carrier substrate attached to the device substrate at a hybrid bonding interface. The carrier substrate includes a strain gauge sensor located at the hybrid bonding interface in which the strain gauge sensor is electrically connected to the at least one pair of spaced apart metal wires at the hybrid bonding interface.

In another embodiment of the present application, the structure includes a device substrate including a plurality of spaced apart metal wires extending entirely through the device substrate, and a carrier substrate attached to the device substrate at a hybrid bonding interface. The carrier substrate of this embodiment includes a strain gauge sensor located at the hybrid bonding interface in which the strain gauge sensor includes a plurality of electrically connected metal foils. In this embodiment, each metal foil is embedded in a flexible dielectric region and is electrically connected to the plurality of spaced apart metal wires.

### BRIEF DESCRIPTION OF THE DRAWINGS

FIG. 1 is a cross sectional view of an exemplary structure in accordance with an embodiment of the present application, in which a strain gauge sensor is located at a hybrid bonding interface between a device substrate and a carrier substrate.

FIG. 2 a top down view illustrating a metal foil of the strain gauge sensor of the present application.

FIGS. 3A-3C illustrate a basic processing flow that can be employed in forming the device substrate of the present application.

FIGS. 4A-4F illustrate a basic processing flow that can be employed in forming the carrier substrate of the present application.

FIG. 5 illustrates a step in hybrid bonding of the device substrate shown in FIG. 3C to the carrier substrate shown in FIG. 4F.

FIG. 6A illustrates a top down view of a portion of the device substrate shown in FIG. 3C prior to hybrid bonding.

FIG. 6B illustrates a top down view of a portion of the carrier substrate shown in FIG. 4F prior to hybrid bonding.

FIG. 6C illustrates a top down view of the exemplary structure after hybrid bonding.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The terms substantially, substantially similar, about, or any other term denoting functionally equivalent similarities refer to instances in which the difference in length, height, or orientation convey no practical difference between the definite recitation (e.g., the phrase sans the substantially similar term), and the substantially similar variations. In one embodiment, substantial (and its derivatives) denote a difference by a generally accepted engineering or manufacturing tolerance for similar devices, up to, for example, 10% deviation in value or 10° deviation in angle.

Throughout the present application, the term “hybrid bonding” denotes dielectric-to-dielectric bonding and metal-to-metal bonding such that a hybrid bonding interface is formed between the bonded dielectric materials and the bonded metals. Throughout the present application, the term “hybrid bonding interface” denotes an interface containing dielectric-to-dielectric bonding and metal-to-metal bonding. Notably, hybrid bonding refers to a 3D packing technique to connect semiconductor builds. Hybrid bonding forms connections of semiconductor structures through metal bond pads which are embedded in a dielectric layer at a bond interface on each semiconductor structure that is being bonded. The metal bond pads embedded in the dielectric surfaces most commonly include, but are not necessarily limited to, copper (Cu). As part of the hybrid bonding process, the aforementioned dielectric materials go through an activation process, including but not necessarily limited to, O₂/N₂ plasma activation followed by a de-ionized water rinsing. Such activation process creates surface dangling bonds through hydroxylation of dielectric surfaces. Hybrid bonding process itself includes alignment to control the overlay of metal pads and to ensure electrical continuity between semiconductor build undergoing hybrid bonding process, mating of dielectric/metal pad surfaces, annealing under a set pressure. The anneal process of the mated semiconductor builds ensures formation of covalent bonds between the dangling bonds across the dielectric surfaces of opposing semiconductor builds, as well as reflow (melting and joining) of the metal pads between the surfaces of opposing semiconductor builds to ensure electrical conductivity. The covalent bonds formed between the dielectric surfaces, and the joining of metal pads as a result of reflow process ensures that hybrid bonding interfaces joins two semiconductor builds and also ensures that there is electrical continuity between them. The dangling bonds and covalent bonding occurs in the present application.

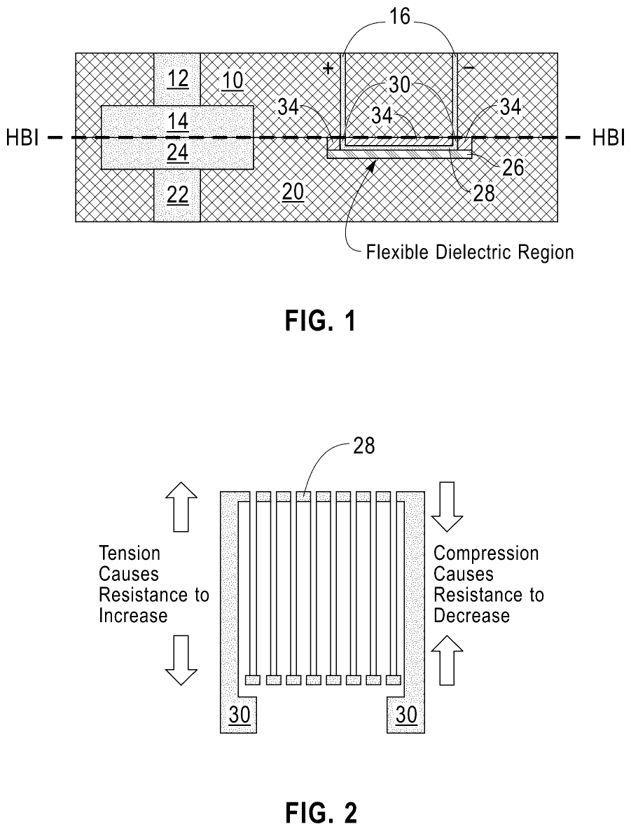

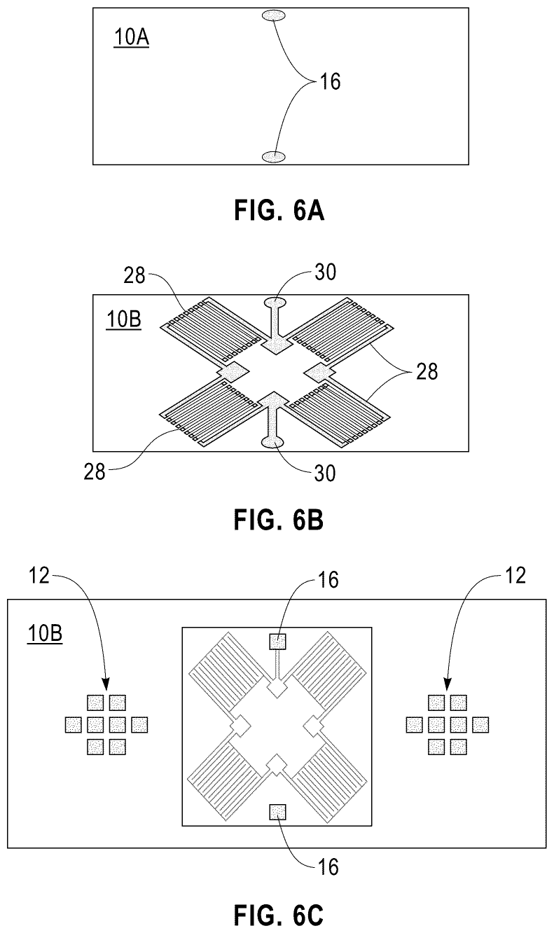

Referring first to FIG. 1, there is illustrated an exemplary structure in accordance with an embodiment of the present application, in which a strain gauge sensor is located at a hybrid bonding interface, HBI, between a device substrate 10 and a carrier substrate 20. It is noted that although FIG. 1 illustrates a single strain gauge sensor, the present application contemplates a plurality of strain gauge sensors which may or may not be electrically connected together. The strain gauge sensor of the present application is a foil strain gauge sensor that includes a metal foil 28 (or a plurality of metal foils) having a meandering (i.e., serpentine) pattern, as illustrated in FIG. 2, located in a flexible dielectric region. The flexible dielectric region includes a first flexible dielectric layer 26 located beneath the metal foil 28 and a second flexible dielectric layer 34 located on top of the metal foil 28; the second flexible dielectric layer 34 is also formed adjacent to the metal foil 28 and can contact a surface of the first flexible dielectric layer 26. The flexible dielectric region can deform upon application of a strain thereto, and the metal foil 28 can change during the application of the strain. The metal foil 28 includes a meandering conductive line as shown in FIG. 2. The metal foil 28 includes a pair of sensor contact pads 30 that extend upward from the metal foil 28 and through the second flexible dielectric layer 34. The pair of sensor contact pads 30 are spaced apart from each other. The metal foil 28, the flexible dielectric region including the first flexible dielectric layer 26 and the second flexible dielectric layer 34, and the sensor contact pads 30 are elements/components of the strain gauge sensor of the present application. The strain gauge sensor of the present application is embedded in the carrier substrate 10. The strain gauge stressor of the present application is configured to measure strain at the hybrid bonding interface. In some embodiments, the strain gauge sensor includes a plurality of electrically connected metal foils, in which each metal foil is composed of a meandering conductive line. In some embodiments typically when an even number of metal foils are employed, the plurality of metal foils are arranged in a crossed formation as shown in FIG. 6C.

The device substrate 10 includes at least one pair of metal wires 16 that are spaced apart from each other. Each metal wire 16 extends entirely through the device substrate 10 as shown in FIG. 1. In the present application, one of the metals wires 16 of the at least one pair of metal wires 16 serves as a positive terminal (+), while the another metal wire 16 of the at least one pair of metal wires 16 serves as a negative terminal (−). Each metal wire 16 is in contact with one of the sensor contact pads 30. The contact between the sensor contact pad 30 and the metal wire 16 occurs at the hybrid bonding interface. Also, present in the device substrate 10 is a first metal via 12 in contact with a first metal line 14.

In addition to including the strain gauge sensor, the carrier substrate 20 also includes a second metal via 22 in contact with a second metal line 24. As is shown in FIG. 1, the second metal line 24 of the carrier substrate 20 contacts the first metal line 14 of the device substrate 10 at the hybrid bonding interface.

The device substrate 10 is composed of at least one dielectric material. Typically, the device substrate 10 is composed of a stack of dielectric materials. The at least one dielectric material that can be employed in the present application in providing the device substrate 10 includes, but is not limited to, silicon oxide, silicon nitride, undoped silicate glass (USG), fluorosilicate glass (FSG), borophosphosilicate glass (BPSG), a spin-on low-k dielectric layer, a chemical vapor deposition (CVD) low-k dielectric layer or any combination thereof. The term “low-k” as used throughout the present application denotes a dielectric material that has a dielectric constant of less than 4.0 (all dielectric constants mentioned herein are relative to a vacuum unless otherwise noted). In some embodiments of the present application, an uppermost portion of the device substrate 10 is composed of a bonding dielectric material such as, for example, tetraethyl orthosilicate (TEOS), silicon dioxide (SiO₂), silicon carbon nitride (SiCN) and/or carbon-doped silicon oxide (SiCOH).

The first metal via 12 and the first metal line 14 that are present in the device substrate 10 are composed of an electrically conductive metal or an electrically conductive metal alloy. Illustrative examples of electrically conductive metals that can be used in the present application include, but are not limited to, Cu, Al, Co, Ru, Mo, Os, Ir, or Rh. An illustrative electrically conductive alloy that can be used in the present application includes, but is not limited to, a Cu—Al alloy. In some embodiments, the first metal via 12 can be composed of a compositionally same electrically conductive material (i.e., metal or metal alloy) as the first metal line 14. For example, Cu can be used as the electrically conductive material for providing both the first metal via 12 and the first metal line 14. In other embodiments, the first metal via 12 can be composed of a compositionally different electrically conductive material (i.e., metal or metal alloy) than the first metal line 14. For example, Co can be used as the conductive material that provides the first metal via 12, while Cu can be used as the conductive metal that provides the first metal line 14.

The metal wires 16 that are present in the device substrate 10 can be composed of an electrically conductive metal or electrically conductive metal alloy, both as exemplified above. The metal wires 16 can be compositionally the same as, or compositionally different from, the first metal via 12 and/or the first metal line 14.

The carrier substrate 20 is composed of at least one dielectric material. Typically, the carrier substrate 20 is composed of a stack of dielectric materials. The at least one dielectric material that can be employed in the present application in providing the carrier substrate 20 includes one of the dielectric materials mentioned above for the device substrate 10. In some embodiments of the present application, an uppermost portion of the carrier substrate 20 is composed of a bonding dielectric material such as, for example, TEOS, SiO₂, SiCN and/or SiCOH.

In the present application, at least one of the device substrate 10 or the carrier substrate 20 typically includes an upper surface that is composed of a bonding dielectric material. In some embodiments, both the device substrate 10 and the carrier substrate 20 have an upper surface that is composed of a bonding dielectric material. The presence of the bonding dielectric material facilitates hybrid bonding between the device substrate 10 and the carrier substrate 20.

The second metal via 22 and the second metal line 24 that are present in the carrier substrate 20 are composed of an electrically conductive metal or an electrically conductive metal alloy, both as exemplified above. In some embodiments, the second metal via 22 can be composed of a compositionally same electrically conductive material (i.e., metal or metal alloy) as the second metal line 24. For example, Cu can be used as the electrically conductive material for providing both the second metal via 22 and the second metal line 24. In other embodiments, the second metal via 22 can be composed of a compositionally different electrically conductive material (i.e., metal or metal alloy) than the second metal line 24. For example, Co can be used as the conductive material that provides the second metal via 22, while Cu can be used as the conductive metal that provides the second metal line 24. In the present application, the second metal line 24 can be composed of a compositionally same, or compositionally different, electrically conductive material compared to the first metal line 14. Typically, the first metal line 14 and the second metal line 24 are composed of a compositionally same electrically conductive material. For example, both the first metal line 14 and the second metal line 24 can be composed of Cu.

The first flexible dielectric layer 26 is composed of a first flexible dielectric material such as, for example, polyimide or polybenzobisoxazole. The second flexible dielectric layer 34 is composed of a second flexible dielectric material such as, for example, polyimide or polybenzobisoxazole. The second flexible dielectric material can be compositionally the same as, or compositionally different from, the first flexible dielectric material.

The metal foil 28 and the sensor contact pads 30 are composed of an electrically conductive metal or electrically conductive metal alloy, both as exemplified above. In some embodiments, the metal foil 28 is composed of a compositionally same electrically conductive material (e.g., Cu) as the sensor contact pads 30. In other embodiments, the metal foil 28 is composed of a compositionally different electrically conductive material than the sensor contact pads 30. In the present application, the sensor contact pads 30 can be composed of a compositionally same, or compositionally different, electrically conductive material compared to the metal wires 16. Typically, the sensor contact pads 30 and the metal wires 16 are composed of a compositionally same electrically conductive material. For example, the sensor contact pads 30 and the metal wires 16 can be composed of Cu.

As illustrated in FIG. 1, the first metal line 14 and the second metal line 24 are in contact with each other and are electrically connected at the hybrid bonding interface. The first metal line 14 and the second metal line 24 are bonded together by a first metal-to-metal bond that is formed during a hybrid bonding process. As is also illustrated in FIG. 1, the metal wires 16 and the sensor contact pads 30 are in contacted with each other and are electrically connected at the hybrid bonding interface. The metal wires 16 and the sensor contact pads 30 are bonded together by a second metal-to-metal bond that is formed during a hybrid bonding process. As is further shown in the FIG. 1, the second flexible dielectric layer 34 is in contact with a dielectric surface (including a bonding dielectric material surface) of the device substrate 10 at the hybrid bonding interface. The second flexible dielectric layer 34 and a dielectric surface (including a bonding dielectric material surface) of the device substrate 10 are bonded together by a first dielectric-to-dielectric bond that is formed during a hybrid bonding process. As is further illustrated in FIG. 1, a dielectric surface (including a bonding dielectric material surface) of the device substrate 10 is contact with a dielectric surface (including a bonding dielectric material surface) of the carrier substrate 20. A second dielectric-to-dielectric bond that is formed during a hybrid bonding process exists between the bonding dielectric material surfaces.

As mentioned above, and in regard to FIG. 2, metal foil 28 has a meandering (i.e., serpentine) pattern. The metal foil 28 can thus change its shape as the flexible dielectric region deforms. The change in the conductive pattern's geometry results in a proportional change in its electrical resistance, which can then be measured and correlated to the applied strain. Notably, and as illustrated in FIG. 2, tension causes the resistance to increase, while compression causes the resistance to decrease.

Notably, FIG. 1 illustrates a structure which includes device substrate 10 including at least one pair of spaced apart metal wires 16 extending entirely through the device substrate 10, and carrier substrate 20 attached to the device substrate 10 at a hybrid bonding interface, HBI. The carrier substrate 20 includes a strain gauge sensor, as defined above, located at the hybrid bonding interface in which the strain gauge sensor is electrically connected to the at least one pair of spaced apart metal wires 16 at the hybrid bonding interface. HBI. The strain gauge sensor is configured to measure strain at the hybrid bonding interface.

In some embodiments of the present application and as illustrated in FIG. 1 and further by FIG. 6C, the structure includes device substrate 10 including a plurality of spaced apart metal wires (i.e., metal wires 16 shown in FIGS. 1 and 6C) extending entirely through the device substrate 10, and carrier substrate 20 attached to the device substrate 10 at a hybrid bonding interface, HBI. The carrier substrate 10 includes a strain gauge sensor located at the hybrid bonding interface in which the strain gauge sensor includes a plurality of electrically connected metal foils 28 (as shown in FIG. 6C). In this embodiment, each metal foil 28 is embedded in a flexible dielectric region (combination of the first flexible dielectric layer 26 and the second flexible dielectric layer 34 and is electrically connected to the plurality of spaced apart metal wires 16. The strain gauge sensor is configured to measure strain at the hybrid bonding interface.

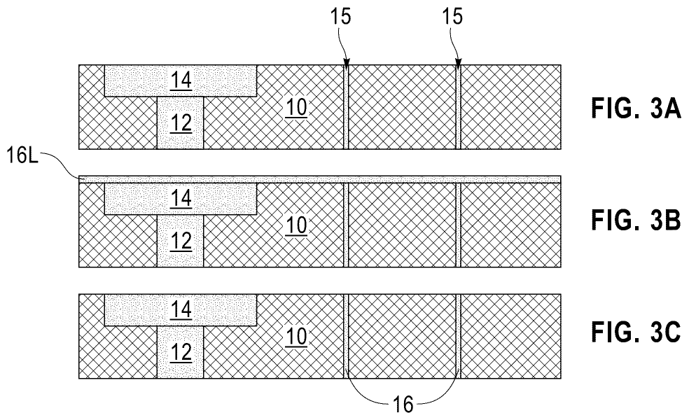

Referring now to FIGS. 3A-3C, there are illustrated a basic processing flow that can be employed in forming the device substrate 10 of the present application. Notably, FIG. 3A illustrates a first exemplary structure including device substrate 10, first metal via 12, first metal line 14 and metal wire openings 15. The metal wiring openings 15 are formed entirely through the device substrate 10. The device substrate 10 minus the metal wire openings 15 can be formed utilizing a metallization process that is well known to those skilled in the art. The metallization process can include forming at least one dielectric layer (including one of the dielectric materials mentioned above for the device substrate 10), forming an opening (line or via) into the at least one dielectric layer, and then filling the opening with one of the electrically conductive metals or electrically conductive metal alloys mentioned above. The steps of dielectric layer formation, opening formation, and electrically conductive material fill can be repeated to provide the first exemplary structure shown in FIG. 3A. The forming the at least one dielectric layer includes depositing one of the dielectric materials mentioned above. The depositing of the dielectric material can include, for example, chemical vapor deposition (CVD), plasma enhanced chemical vapor deposition (PECVD) or spin-on coating. The forming of the opening can include lithography and etching. Lithography includes forming (by a deposition process) a photoresist material on a layer or structure that needs to be patterned, exposing the as-deposited photoresist material to a desired pattern of irradiation, and developing the exposed photoresist material. The etching can include a dry etching process or a wet etching process. Drying etching can include, for example, reactive ion etching (RIE), laser etching, or plasma etching. Wet etching includes the use of a chemical etchant. The filling of the opening includes depositing an electrically conductive metal or an electrically conductive metal alloy, as defined above, and then performing a planarization process such as, for example, chemical mechanical polishing (CMP), to remove any of the as-deposited electrically conductive material that is formed outside of the opening. The depositing of the electrically conductive material can include, but is not limited to, CVD, PECVD, atomic layer deposition (ALD), sputtering or plating. After metallization that provides the first metal line 14, the metal wire openings 15 are formed into the device substrate 10 by lithography and etching as defined above. The metal wiring openings 15 extend from a topmost surface of the device substrate 10 to a bottommost surface of the device substrate 10. The metal wire openings 15 pass through the one or more dielectric layers that provide the device substrate 10.

Next, and as is shown in FIG. 3B, an electrically conductive material layer 16L composed of an electrically conductive metal or electrically conductive metal alloy, as described above, is formed on top of the device substrate 10 and within each of the metal wiring openings 15. The electrically conductive material layer 16L fills an entirety of each of the metal wiring openings 15 as is illustrated in FIG. 3B. The forming of the electrically conductive material layer 16L includes a deposition process such as, but not limited to, CVD, PECVD, ALD, sputtering or plating.

Next, and as is illustrated in FIG. 3C, the first exemplary structure shown in FIG. 3B is subjected to a planarization such as, for example, CMP, to remove the electrically conductive material layer 16L that is formed on top of the device substrate 10. A portion of the electrically conductive material layer 16L remains in each of the metal wiring openings 15. The remaining portion of the electrically conductive material layer 16L that is present in each of the metal wiring openings 15 provides the spaced apart metal wires 16 of the device substrate 10.

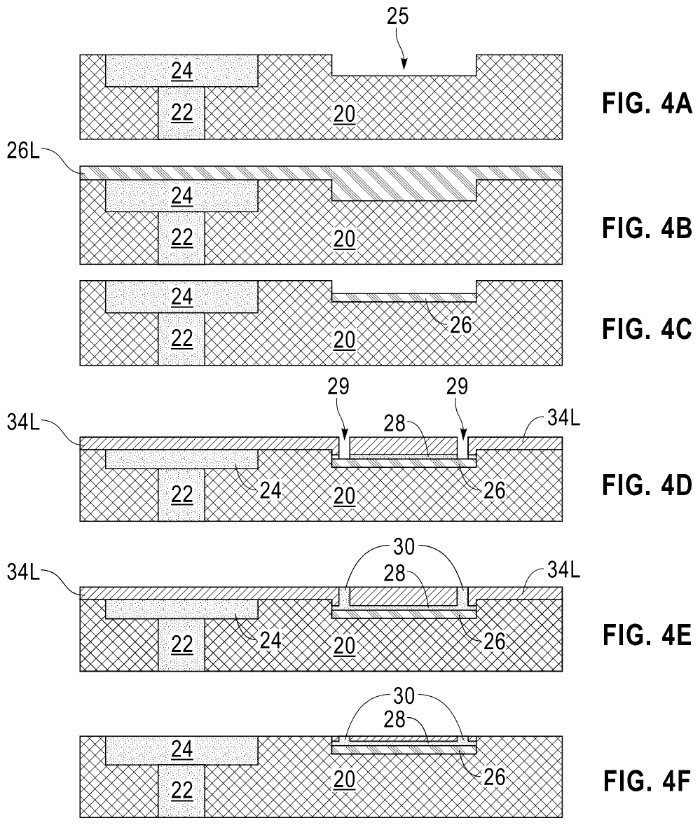

Referring now to FIGS. 4A-4F, there are illustrated a basic processing flow that can be employed in forming the carrier substrate 20 of the present application. Notably, FIG. 4A illustrates a second exemplary structure including carrier substrate 20, second metal via 22, second metal line 24 and a strain gauge sensor opening 25. In embodiments, a plurality of strain gauge openings 25 can be formed. The strain gauge sensor opening 25 is formed within an upper portion of the carrier substrate 20. The carrier substrate 20 minus the strain gauge sensor opening 25 can be formed utilizing a metallization process as defined above. After the metallization that provides the second metal line 24, the strain gauge sensor opening 25 is formed by lithography and etching, as defined above. Although not shown in the cross sectional view of FIG. 4A, the strain gauge opening 25 has a meandering pattern. When a plurality of strain gauge openings are formed, they can be arranged in a crossed formation.

Next, and as is illustrated in FIG. 4B, a layer of first flexible dielectric material 26L is formed on top of the carrier substrate 20 and in the strain gauge sensor opening 25. The layer of first flexible dielectric material 26L fills in the entirety of the strain gauge opening 25. The layer of first flexible dielectric material 26L can be formed a deposition process including, for example, CVD, PECVD, physical vapor deposition (PVD), evaporation or spin-on coating. The layer of first flexible dielectric material 26L is composed of a first flexible dielectric material as mentioned above.

After forming the layer of first flexible dielectric material 26L, a planarization process (including CMP) and an etch back process are used to convert the layer of first flexible dielectric material 26L into the first flexible dielectric layer 26, as is illustrated in FIG. 4C. The planarization process removes the layer of first flexible dielectric material 26L that is formed on top of the carrier substrate 20. A portion of the layer of first flexible dielectric material 26L remains in the strain gauge opening 25 that has a topmost surface that is substantially coplanar with a topmost surface of the carrier substrate 20. The remaining portion of the layer of first flexible dielectric material 26L in the strain gauge opening 25 is subjected to the etch back process. The etch back process is selective in removing an upper portion of the first flexible dielectric material that is within the strain gauge opening 25. The first flexible dielectric material that remains in the strain gauge opening 25 after the etch back process is the first flexible dielectric layer 26.

Next, and as is illustrated in FIG. 4D, metal foil 28 and a patterned layer of second flexible dielectric material 34L are formed. Notably, the metal foil 28 can be formed by deposition of a layer of electrically conductive material (i.e., electrically conductive metal or electrically conductive metal alloy, as mentioned above), followed by planarization (e.g., CMP) and an etch back process which converts the layer of electrically conductive material into metal foil 28. The deposition of the layer of electrically conductive material that provides the metal foil 28 includes, but is not limited to, CVD, PECVD, ALD, sputtering or plating. The etch back process is selective in removing an upper portion of the layer of electrically conductive material that remains after planarization. It is noted that metal foil 28 has a meandering pattern. After metal foil 28 formation, the patterned layer of second flexible dielectric material 34L is formed. The patterned layer of second flexible dielectric material 34L is formed by deposition of a second flexible dielectric material, followed by lithography and etching. The deposition of the second flexible dielectric material includes, for example, CVD, PECVD, PVD, evaporation or spin-on coating. The etch stop on the metal foil 28 and forms sensor contact pad openings. Each sensor contact pad opening physically exposes a surface of the metal foil 28.

Next, and as is illustrated in FIG, 4E, a sensor contact pad 30 is formed in each of the sensor contact pad openings 29. The forming of the sensor contact pads 30 includes filling via a deposition process (e.g., CVD, PECVD, ALD, sputtering or plating) each sensor contact pad opening 29 with an electrically conductive material (i.e., an electrically conductive metal or an electrically conductive metal alloy, as mentioned above), and then removing any electrically conductive material that is formed outside the sensor contact pad openings 29.

Referring now to FIG, 4F, there is illustrated the second exemplary structure of FIG. 4E after performing a planarization process (e.g., CMP). The planarization process removes the patterned layer of second flexible dielectric material 34L that is formed on top of the carrier substrate 20. A portion of the patterned layer of second flexible dielectric material 34L remains in the strain gauge opening 25 and provides the second flexible dielectric layer 34. As is illustrated in FIG. 4F, the second metal line 24 has a topmost surface that is substantially coplanar with a topmost surface of each of the carrier substrate 20, the sensor contact pads 30 and the second flexible dielectric layer 34.

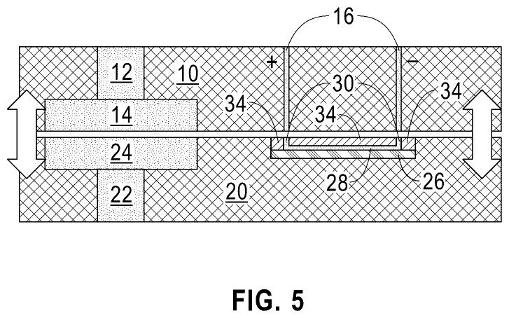

Referring now to FIG. 5, there is illustrated a step in hybrid bonding of the device substrate 10 shown in FIG. 3C to the carrier substrate 20 shown in FIG. 4F. Notably, FIG. 5 illustrates a step in which the first exemplary structure shown in FIG. 3C is flipped and aligned over the second exemplary structure shown in FIG. 4F. In the present application, the first exemplary structure shown in FIG. 3C is flipped 180°. Flipping can be performed by hand or by utilizing a mechanical means such as, for example, a robot arm. The aligning includes positioning the flipped first exemplary structure shown in FIG. 3C over the second exemplary structure shown in FIG. 4F such that first metal line 14 is aligned over the second metal line 24 and such that the each metal wire 16 is aligned over one of the sensor contact pads 30. It should be noted that although the present application illustrates the flipping of the first exemplary structure, embodiments are possible in which the second exemplary structure is flipped and aligned above the first exemplary structure.

The aligned first exemplary structure and second exemplary structure illustrated in FIG. 5 are then brought into intimate contact with each other, and thereafter the hybrid bonding process continues to provide the exemplary structure shown in FIG. 1. The bringing the aligned first exemplary structure and second exemplary structure illustrated in FIG. 5 into intimate contact with each other (represented by the double headed arrows in FIG. 5) can include the application of an external force which may or may not remain during a heating (i.e., annealing) step of the hybrid bonding process. The heating step of the hybrid bonding process provides metal-to-metal bonding and dielectric-to-dielectric bonding as described above. Heating can be performed from room temperature (i.e., 20° C.-25° C.) typically up to 450° C.; temperatures greater than 450° C. can also be used in the present application. The heating step of the hybrid bonding process is typically performed in an inert ambient such as, for example, He, Ar, Ne or mixtures thereof. After hybrid bonding of the first exemplary structure and second exemplary structure, the temperature can be lowered back to room temperature. The bonding process can also include an activation process as described above. The heating forms a bonded structure as illustrated in FIG. 1 in which the strain gauge sensor is located at the hybrid bonding interface. The bonded structure illustrated in FIG. 1 includes metal-to-metal bonding and dielectric-to-dielectric bonding as mentioned above.

Referring now to FIG. 6A, there is illustrated a top down view of a portion of the device substrate 10 shown in FIG. 3C prior to hybrid bonding. The portion that is illustrated in FIG. 6A includes the area in which the metal wires 16 are located. In FIG. 6A, a topmost device substrate surface 10A is shown. The topmost device substrate surface 10A can be composed of a dielectric bonding material as defined above. Referring now to FIG. 6B, there is illustrated a top down view of a portion of the carrier substrate 20 shown in FIG. 4F prior to hybrid bonding. The portion that is illustrated in FIG. 6B includes the area in which the strain gauge sensor of the present application is located. In FIG. 6B, a topmost carrier substrate surface 20A is shown. The topmost carrier substrate surface 20A can be composed of another dielectric bonding material as defined above. Referring now to FIG. 6C, there is illustrated a top down view of the exemplary structure after hybrid bonding. The strain gauge stressor of the carrier substrate 20 is shown to emphasize the location of the same.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A structure comprising:
a device substrate comprising at least one pair of spaced apart metal wires extending entirely through the device substrate; and
a carrier substrate attached to the device substrate at a hybrid bonding interface, wherein the carrier substrate comprises a strain gauge sensor located at the hybrid bonding interface, wherein the strain gauge sensor is electrically connected to the at least one pair of spaced apart metal wires at the hybrid bonding interface.

2. The structure of claim 1, wherein the strain gauge sensor comprises at least one metal foil embedded in a flexible dielectric region.

3. The structure of claim 2, wherein the strain gauge sensor further comprises at least one pair of spaced apart sensor contact pads, each sensor contact pad of the at least one pair of spaced apart sensor contact pads is electrically connected to one metal wire of the at least one pair of spaced apart metal wires at the hybrid bonding interface.

4. The structure of claim 2, wherein the at least one metal foil is composed of an electrically conductive line having a meandering pattern.

5. The structure of claim 2, wherein the flexible dielectric region comprises a first flexible dielectric layer located beneath the at least one metal foil and a second flexible dielectric layer located on top of, and laterally adjacent to the at least one metal foil.

6. The structure of claim 1, wherein the hybrid bonding interface comprises a combination of a dielectric to-dielectric bond and a metal-to-metal bond.

7. The structure of claim 1, wherein the device substrate further comprises a first metal line and the carrier substrate further comprises a second metal line, wherein the second metal line is in contact with, and electrically connected to, the first metal line at the hybrid bonding interface.

8. The structure of claim 1, wherein the strain gauge sensor is configured to measure strain at the hybrid bonding interface.

9. The structure of claim 1, wherein the strain gauge sensor comprises a plurality of electrically connected metal foils, wherein each metal foil is embedded in a flexible dielectric region and is composed of an electrically conductive line having a meandering pattern.

10. The structure of claim 9, wherein the plurality of electrically connected metal foils are arranged in a crossed formation.

11. A structure comprising:
a device substrate comprising a plurality of spaced apart metal wires extending entirely through the device substrate; and
a carrier substrate attached to the device substrate at a hybrid bonding interface, wherein the carrier substrate comprises a strain gauge sensor located at the hybrid bonding interface, wherein the strain gauge sensor comprises a plurality of electrically connected metal foils, wherein each metal foil is embedded in a flexible dielectric region and is electrically connected to the plurality of spaced apart metal wires.

12. The structure of claim 11, wherein the strain gauge sensor further comprises a pair of spaced apart sensor contact pads contacting each metal foil of the plurality of electrically connected metal foils.

13. The structure of claim 12, wherein each sensor contact pad of the pair of spaced apart sensor contact pads is electrically connected to a metal wire of the plurality of spaced apart metal wires at the hybrid bonding interface.

14. The structure of claim 11, wherein each metal foil of the plurality of electrically connected metal foils is composed of an electrically conductive line having a meandering pattern.

15. The structure of claim 11, wherein the plurality of electrically connected metal foils are arranged in a crossed formation.

16. The structure of claim 11, wherein the hybrid bonding interface comprises a combination of a dielectric to-dielectric bond and a metal-to-metal bond.

17. The structure of claim 11, wherein the device substrate further comprises a first metal line and the carrier substrate further comprises a second metal line, wherein the second metal line is in contact with, and electrically connected to, the first metal line at the hybrid bonding interface.

18. The structure of claim 11, wherein the flexible dielectric region comprises a first flexible dielectric layer located beneath each metal foil of the plurality of electrically connected metal foils and a second flexible dielectric layer located on top of, and laterally adjacent to each of the metal foils of the plurality of electrically connected metal foils.

19. The structure of claim 11, wherein the strain gauge sensor is configured to measure strain at the hybrid bonding interface.
